(19) United States
(12) Patent Application Publication
(10) Pub. No.: US 2016/0120180 A1
(43) Pub. Date: May 5, 2016

(54) COMPOSITIONS AND METHODS FOR CONTROLLING REPLANT DISEASES OF PERENNIAL CROPS

(71) Applicant: Adjuvants Unlimited LLC, Memphis, TN (US)

(72) Inventors: Kevin E. Crosby, Germantown, TN (US); Mickey R. Brigance, Germantown, TN (US); Jennifer Jordan-Bear, Cordova, TN (US); Shana Hall, Falkner, MS (US); William Robert Fowlkes, Collierville, TN (US)

(73) Assignee: Adjuvants Unlimited LLC, Memphis, TN (US)

(21) Appl. No.: 14/928,976

(22) Filed: Oct. 30, 2015

Related U.S. Application Data
(60) Provisional application No. 62/073,002, filed on Oct. 30, 2014.

(51) Int. Cl. A01N 37/02

(52) U.S. Cl. CPC A01N 37/02

(57) ABSTRACT

The present invention relates to compositions and methods for treating a broad set of syndromes collectively known as replant diseases or replant problems without harming the treated plant. The compositions and methods include fatty acids and combinations of fatty acids that are environmentally safe, yet highly effective at treating replant disease and its symptoms. The compositions and methods of the present invention do not result in the creation of toxic waste that requires special disposal. The compositions and methods of the present invention do not require buffer zones where no application can be made. The compositions and methods of the present invention do not require modification of fatty acids that decrease their effective pesticidal activity. The compositions and methods of the present invention do not result in phytotoxicity of growing plants. The compositions and methods of the present invention cause vigorous growth and reversal of symptoms of plants affected with replant disease, including faster development of productive spurs/stems and larger fruit.

### CROSS-REFERENCE TO RELATED APPLICATIONS

This application claims the benefit of U.S. Provisional Application No. 62/073,002, which was filed Oct. 30, 2014, and is hereby incorporated by reference in its entirety for all that it teaches.

### FIELD OF THE INVENTION

The present invention relates to compositions and methods for controlling a broad set of syndromes collectively known as replant diseases or replant problems that afflict many perennial crops including stone fruits (especially from the genus Prunus), pome fruits, citrus fruits, and other perennial plants.

### BACKGROUND OF THE INVENTION

Replant disease (also known as replant problem, replant syndrome, or sick soil) is recognized as a major impediment to establishing healthy, productive orchards, groves vineyards and other fields. When an established orchard has reached the end of its useful economic life, new, young transplants are commonly replanted into the existing orchard ground. Often, the transplants either die or grow poorly when replanted into the same crop area. Replant diseases of perennial crops are widely recognized in many diverse species. Replant disease has been recognized in apples (U.S. Pat. No. 5,948,671 to Mazzola; Hoestra, Replant Diseases of apple in the Netherlands. Ph.D. thesis. Meded. Landbouwhogesch Wageningen, The Netherlands (1968)), almonds (Browne et al., Managing the almond and stone fruit replant disease complex with less fumigant. California Agriculture 67(3) 128-138 (2013)), Citrus (Tsao et al., The Citrus Replant Problem in The Citrus Industry, Vol. 5, ed. W. Reuther (1989)), peaches (Bent et al., Investigations into peach seedling stunting caused by a replant soil. FEMS Microbial Ecology 68:192-200 (2009); Yang et al., Correlations between Root-Associated Microorganisms and Peach Replant Disease Symptoms in a California Soil. PLoS One 7(10):e46420 (2012)), cherries (Mai & Abawi, Determining the Cause and Extent of Apple, Cherry and Pear Replant Diseases under Controlled Conditions. Phytopathology 68:1540-1544 (1978)), and blueberries (Jagdale et al., Incidence and Pathogenicity of Plant-Parasitic nematodes Associated with Blueberry (Vaccinium spp.) Replant diseases in Georgia and North Carolina. J. Nematology 45:92-98 (2013)). The problem is so widespread in species of the genus Prunus that the syndrome has earned the general name of “Prunus replant disease” (PRD) (Browne et al. (2013), supra).

The cause of replant disease has not been scientifically established, but it is currently thought to be caused by a poorly understood complex of factors. Within the general syndrome described as “replant disease,” numerous factors have been implicated as causative agents, such as nematodes, fungi, bacteria, other microorganisms, and sometimes organic matter (e.g., root residues from the previous crop that varies from species to species). Abiotic factors such as soil structure and nutrient status (Mai & Abawi, Controlling replant diseases of pome and stone fruits in Northeastern United States by preplant fumigation. Plant Disease 65:859-864 (1981); Tsao et al., supra) have been suggested. In some cases, like peaches, the release of phytotoxic residues from the decay of roots from the preceding crop has been implicated (Proebsting & Gilmore, The relation of peach root toxicity to the re-establishing of peach orchards. Proc Am Soc Hort Sci 38:21-26 (1941); Benizri et al., Replant diseases: bacterial community structure and diversity in peach rhizosphere as determined by metabolic and genetic finger printing. Soil Biol Biochem 37:1738-1746 (2005)). Microbial species have also been widely suggested as causative agents, including bacteria (Utkhede et al., Effects of nematodes, fungi, and bacteria on the growth of young apple trees grown in apple replant disease soil. Pant & Soil 139:1-6 (1992)), fungi (Mazzola, Elucidation of the microbial complex having a causal role in the development of Apple Replant Disease in Washington. Phytopathology 88:930-938 (1998)), stramenophiles (Bent et al., supra), complexes of fungi and oomycetes including the genus Pythium, Phytophthora, Rhizoctonia and Cylindrocarpon (Mazzola (1998), supra), and nematodes (Mai & Abawi (1981), supra; Hoestra, supra). However, Browne et al. state that replant disease can occur in the absence of nematodes and can occur on its own or in conjunction with other replant problems such as nematodes or fungal pathogens (Browne et al. (2013), supra; Browne et al., Almond replant disease and its management with alternative preplant fumigation treatments and rootstocks. Plant Disease 90:869-76 (2006)). Melakeberhan et al. found nematodes in many cherry orchards suffering from poor growth, but there was no difference in nematode numbers in the soil between healthy and declining trees (Melakeberhan et al., Factors associated with the decline of sweet cherry trees in Michigan: Neamtodes, bacterial canker, nutrition, soil pH and winter injury. Plant Disease 77: 266-271 (1993)).

Surveys of California almond orchards (McKenry & Kretsch, Survey of nematodes associated with almond production in California. Plant Disease 71:71-73 (1987)) indicated that nematode species are not uniformly found in orchards with replant disease and that the most common nematode species was only found in 61% of replant disease afflicted orchards. As a result of the variation in causative factors, replant disease is often described as a “poorly understood soilborne disease complex” (Browne et al. (2013), supra). While nematodes remain a suspected agent or co-agent of replant diseases, it is clear that nematocidal activity alone is insufficient to control replant diseases. For example, Browne et al. stated that “[t]here was no association between nematodes and RD [almond replant disease] in orchard or microplot trials (Browne et al. (2006), supra). The RD apparently was mediated by a biological agent(s) other than nematodes and can be prevented by appropriate fumigation with CP [chloropicrin] or other MB [methyl bromide]alternatives.” Utkhede et al. suggest that fungi, bacteria, or nematodes alone or their combinations may cause apple replant disease (Utkhede et al., supra).

Without a clearly defined causative agent, it is difficult to propose specific treatment options for each crop species or for unique geographical locations. The poorly defined nature of replant disease still eludes uniform recommendations for treatment or cure.

In addition to effects on recently transplanted trees, the effects of replant disease can linger for many years affecting overall plant productivity for at least 9 years and possibly for the whole life-cycle of an orchard. Mazzola states that reduced vigor of replanted trees can result in economic losses of up to $40,000 per acre in reduced gross returns over a 10 year period (U.S. Pat. No. 5,948,671 to Mazzola). This is caused by a delay in economic bearing of fruit by 2-3 years and reduced yield compared to disease-free trees. For example, cumulative yield over the lifetime of an almond orchard is irreversibly reduced due to any yield reduction in years 3-9 after replanting (Browne et al. (2013), supra). According to the US Environmental Protection Agency (2010), the effects of replant disease include direct and indirect economic loss: tree loss, cost of replanting to replace tree loss, loss of replanted trees, yield loss of fruit or nuts, delayed achievement of full yield potential, and earlier loss of productivity of whole orchard. In Australian apples, claims that untreated replant disease can cause economic losses of up to $182,000 per hectare in the first seven years of an orchards life (Brown, Soil Treatments against replant pests and diseases. (2013)). Consequently, replant disease can have a permanent effect on orchard productivity both due to initial effects on plant establishment and long term stress that takes years for the plants to recover.

Currently approved treatments to alleviate replant disease are dominated by the chemical fumigants chloropicrin (“CP”) and 1,3-dichloropropene (“1,3-D”), which may be applied alone or in combination with one another. One common fumigant product is called TELONE C35 ®, which is a 34.7% chlorpicrin and 63.4% 1,3-D combination (Dow AgroSciences TELONE C35® label). However, the use of fumigants is fraught with risk. Fumigants are very toxic to a wide variety of organisms (including humans) and must be used under very carefully prescribed conditions. Some reported effects on humans include lung, liver, and kidney damage, and can be fatal via inhalation. Soil treated with volatile fumigants must be covered with vapor resistant barriers (plastic or metallized plastic) to contain the vapors in treated soil. These vapor barriers then need to be handled and disposed of as toxic waste, which adds considerable expense to the fumigant process. In addition, wide buffer zones are required around treated soils until the product has dissipated in the soil (California Department of Pesticide Registration, Methyl Bromide Critical Use Renomination for Preplant Soil Use (Open Field or Protected Environment) (2010)). Thus, large areas of fields cannot be treated using conventional fumigation such as by public right of ways, adjacent residential areas, and school zones, which results in further economic loss for the grower. Finally, large amounts of fumigant (up to 540 lbs. per acre) are required for treatment. This results in very expensive direct costs to the grower (up to $1200 per acre), which includes fumigant, application, labor, and disposal of the vapor barriers.

Very large growth responses of Prunus species are observed when planted into old orchard ground that has been treated with fumigants compared to untreated old orchard soil. The impact of fumigation can last for several years (Browne et al. (2013), supra) and can be an essential step in maximizing net revenues in replanted orchards. However, fumigation cannot be effectively repeated after the orchard has been replanted, so there is no possibility of re-treatment if replant disease organisms re-occur in an orchard. Current technology (e.g., fumigations) cannot be applied to whole plants to counteract this effect as the fumigants are phytotoxic to the plants (Mattner et al., Phytotoxicity and plant-back—Critical issues in the Australian strawberry industry. (2003)). For example, in citrus orchards, chloropicrin/1,3-D combinations cannot be applied closer than five feet from existing trees as this would cause phytotoxicity (Dow Agrosciences TELONE C35® label). This positive benefit of fumigation is the reason these toxic materials are permitted in modern agriculture as there are no viable economic alternatives presently. Thus, safer and effective alternatives to fumigation for control of replant disease are urgently needed for positive environmental reasons (elimination of worker exposure, reduced risk to the public, etc.) and ease of use for the grower. Elimination of the required buffer zones for fumigants would allow for more productive use of land, which cannot be currently re-planted without replant disease. A treatment that counteracts not just first year effects but also long term impacts of replant disease is greatly needed by the orchard industry.

Fatty acids are a group of naturally occurring compounds that are commercially produced from triglycerides via splitting of the fatty acids from a glycerol backbone. (Gervajio. Fatty acids and derivatives from coconut oil. Kirk-Othmer Encyclopedia of chemical Technology. 1-38 (2012)). Fatty acids with less than 6 carbons are called short chain, medium chain fatty acids have 6-12 carbons, long chain fatty acids have 13-21 carbons, and very long chain fatty acids have 22 or more carbons. Both saturated and unsaturated (e.g., stearic and oleic acids, respectively) fatty acids are observed in nature. Medium, long, and very long fatty acids are not soluble in water and, to be useful for many agricultural applications, must either be converted into water soluble salts (known as soaps) or combined with surfactants to form an emulsifiable product. Fatty acids have myriad biological roles in nature, especially as components of membranes and energy metabolism. Independent of these functions, other effects are observed. Of particular interest is the activity of fatty acids as pesticides. Fatty acids have several desirable traits as pesticides. First, there is very little toxicity to mammals and fish, and some (such as C8 and C10 chain lengths) fatty acids are designated “Generally Regarded as Safe” by the U.S. Food and Drug Administration for direct food consumption. This is not surprising considering fatty acids are generally derived from natural edible oils. Second, because fatty acids are essential components of microbial metabolism they are rapidly degraded in the environment and have very short half-lives in soil. Aside from possible eye and skin irritation among pesticide handlers, there is very little short or long term safety or environmental hazards inherent in fatty acids.

Fatty acids were first reported to have effects on nematodes in 1956 (Tarjan and Cheo, Nematicidal value of some fatty acids, Bulletin 332, Contribution 884, Agricultural Experiment Station, University of Rhode Island, Kinston, R.I., (1956)). They tested undecylenic acid (unsaturated 11 carbon fatty acid) against Meloidogyne incognita and found the fatty acid destroyed isolated egg masses in vitro but gave no systemic effects on nematodes when sprayed on plant foliage as a dilute emulsion. However, when an emulsion was applied to soil at 2 and 4 grams of fatty acid per square foot, the test plants died. Tarjan and Cheo showed that certain emulsions of fatty acids were more effective than others as nematicides, and that micro-emulsions with high levels of surfactants were the least effective type of emulsion for toxicity to nematodes (Tarjan & Cheo, supra). When tested against Panagrellus redivivus the most effective carbon chain lengths were C6-C12, with declining activity at both shorter and longer carbon chain lengths. In a soil-applied treatment of undecylenic acid on bermudagrass, a reduction in nematode number was observed.

There has been continued interest in fatty acids as environmentally acceptable treatments to control nematodes. However, the reported phytotoxicity of fatty acids applied to plants either foliarly or via soil application has raised concerns about commercial usage. The phytotoxicity of fatty acids and their salts is well known and has long been assumed to be a barrier to the use of these compositions on living plants. The C9 saturated fatty acid, nonanoic acid (also known by the obsolete pelargonic acid), is sold as a non-selective herbicide in both an emulsifiable form (Gowan Corporation, SCYTHE® herbicide label) and as a water soluble ammonium salt (Biosafe Systems LLC, AXXE® herbicide label). The mitigation of the undesirable phytotoxic effects while preserving pesticidal activity is a major area of research. U.S. Pat. No. 3,931,413 to Frick and Burchill teaches that fatty acids can control certain fungi on dormant trees, but specifically warn not to treat actively growing tissue due to phytotoxicity. U.S. Pat. No. 5,246,716 to Sedun and Kulenkampff claims that some salts of fatty acids such as sodium and potassium are inherently phytotoxic, while other metal salts such as calcium, copper, magnesium, and zinc can be used as fungicides without phytotoxicity.

The esterification of fatty acids has been shown to significantly decrease their phytotoxicity (U.S. Pat. Nos. 5,674,897 and 5,698,592 to Kim et al., and U.S. Pat. No. 6,124,359 to Feitelson & Dullum). Such modifications can, however, lead to dramatic loss of pesticidal activity as is seen for linoleic (polyunsaturated C18), linolenic (polyunsaturated C18), and oleic acid (monounsaturated C18); Stadler et al., Fatty acids and other compounds with nematicidal activity from cultures of Basdiomycetes. Planta Medica 60:128-132 (1994)). In U.S. Pat. No. 6,903,052 and U.S. Pat. No. 6,887,900, Williams et al. propose that “it may be impossible” to completely decouple the phytotoxicity and pesticidal activity of fatty acids because of their non-specific mode of action (emphasis added). Perhaps not surprisingly, the pesticidal fatty acid pelargonic acid methyl ester (U.S. Pat. Nos. 5,674,897 and 5,698,592 to Kim et al., and U.S. Pat. No. 6,124,359 to Feitelson & Dullum) shows a relatively small ‘therapeutic window’ between the onset of pesticidal activity and the observation of significant phytotoxicity (Davis et al. Nematicidal Activity of Fatty Acid Esters on Soybean Cyst and Root-knot Nematodes. J. Nematol. 29(4S):677-684 (1997)). This is the expected result if both the phytotoxicity and the pesticidal activity derive from the non-specific disruption of plasma membrane integrity.

The positive effects of fatty acids are, therefore, antagonized by the unfortunate side effect of phytotoxicity. If the phytotoxic effects of fatty acids could be overcome, this class of compounds could provide useful pesticidal activity. Several solutions have been proposed (e.g., U.S. Pat. Nos. 6,903,052 and 6,887,900 to Williams et al., and U.S. Pat. No. 5,698,592 to Kim et al.), which generally involve making derivatives of fatty acids, such as esters. Unfortunately, the derivative forms of fatty acids are generally less active than the parent fatty acids and are not as useful for control of disease or nematodes.

Of the examples cited above, none teach the following: 1) use of fatty acids to treat replant diseases, 2) the use of combinations of fatty acids for treating replant disease, or 3) application to soil for treating replant disease. In fact, many specifically teach against applying fatty acids on actively growing plants due to the well-documented phytotoxicity of fatty acids with pesticidal activity. In summary, more environmentally acceptable products and methods for control of replant disease(s) are urgently needed, especially for treating soil both pre-planting and post-planting to prevent re-infestation of healthy plants or treat replant disease in a plant in situ.

### SUMMARY OF THE INVENTION

The present invention overcomes the deficiencies of the prior art by providing compositions and methods that are environmentally safe, yet highly effective at treating a broad set of syndromes collectively known as replant diseases or replant problems without harming the treated plant. The compositions and methods of the present invention do not result in the creation of hazardous waste such as plastic vapor barriers that require special disposal. The compositions and methods of the present invention do not require buffer zones where no application can be made. The compositions and methods of the present invention do not require modification of fatty acids that decrease their effective pesticidal activity. The compositions and methods of the present invention do not result in phytotoxicity of growing plants. The compositions and methods of the present invention reverse the impact of replant disease on affected plants, causing vigorous growth resulting in faster development of productive spurs/stems and larger fruit.

In one aspect, the present invention provides compositions of fatty acids or combinations of fatty acids that are effective in treating replant disease. The compositions can be applied to the soil of an orchard or other land where perennial plants are grown. The compositions can be applied either before or after new perennial plants are replanted. The compositions can be used to treat replant disease in a variety of perennial plants with susceptibility to replant disease, such as stone fruits (especially Prunus genus plants, such as almond, peach, plum, cherries, etc.), pome fruits (apple, pears, etc.), citrus fruits (orange, grapefruit, lemon, etc.), and other perennial plants (such as blueberry, rose, grapes and others).

In another aspect, the present invention provides methods of treating replant disease. The methods include the application of compositions of fatty acids or combinations of fatty acids that are effective in treating replant disease. The methods include treating soil of an orchard or other land where perennial plants are grown. The methods may include treating soil either before or after new perennial plants are replanted. The methods can be used to treat replant disease in a variety of perennial plants with susceptibility to replant disease, such as stone fruits (especially Prunus genus plants, such as almond, peach, plum, cherries, etc.), pome fruits (apple, pears, etc.), citrus fruits (orange, grapefruit, lemon, etc.), and other perennial plants (such as blueberry, rose, grapes and others).

### BRIEF DESCRIPTION OF THE DRAWINGS

Further advantages of the invention will become apparent by reference to the detailed description of preferred embodiments when considered in conjunction with the drawings:

FIG. 1 shows a representative control (untreated) tree at 60 days after treatment of experimental trees.

FIG. 2 shows a representative experimental tree at 60 days after treatment with one gallon of 1% mix of Composition 1.

FIG. 3 shows a representative experimental tree at 60 days after treatment with one gallon of 2% mix of Composition 1.

FIGS. 4A and 4B show a comparison at 60 days after treatment of three untreated almond trees with three almond trees that were treated with one gallon of 2% mix of Composition 1.

FIG. 5 shows the impact of increased growth on harvested almond size from an experimental (treated with one gallon of 1% mix of Composition 1) almond tree (left) compared with an untreated control almond trees (right).

### DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

This invention relates to compositions and methods to control and reverse replant diseases in economically useful perennial crop plants (including fruits, nuts, roses, or other harvestable products) in need thereof when they are grown in a cultural system that requires periodic replanting of the perennial crop plant. Surprisingly, we have found that replant disease symptoms can be controlled and reversed by soil applications of compositions containing formulated combinations of fatty acids without damage to the crop plants themselves. Furthermore, the compositions can be applied to the soil of actively growing perennial plants in need thereof without causing phytotoxic symptoms. Perhaps most surprising, the compositions can include fatty acids that are well documented to be highly phytotoxic, such as C9 nonanoic acid, which is sold commercially as a herbicide.

In one aspect, the present invention provides compositions of fatty acid(s) or salts thereof that are effective at treating, controlling, and reversing replant disease in perennial plants susceptible of or suffering from replant disease (plant in need thereof). Compositions of free fatty acids are insoluble in water and must be formulated using well-known, standard formulation methods. Any free fatty acid or salt thereof with a carbon chain of between C6 to C22 with pesticidal activity can be used in the present compositions and methods. Preferably, the fatty acids have a carbon chain of between C8 to C16 with pesticidal activity. In more preferred embodiments, the fatty acids have a carbon chain of between C8 to C12 with pesticidal activity. The concentration of fatty acids can be between 0.1% and 95% in a composition concentrate and between 0.01% and 25% in a diluted working solution. The diluted working solution is preferably an aqueous solution. To maintain the fatty acids thereof in an aqueous solution, an emulsifying agent is included in the compositions. It is contemplated that any US EPA registered emulsifier can be used in connection with the present invention for concentrates and diluted working solutions.

In some embodiments, optional components may be incorporated into the compositions, including one or more solvent(s), and/or a hard water ion complexing agent, and/or a defoamer. When a solvent is included, preferably the solvent is any agriculturally acceptable solvent that is approved for use in pesticide formulations by the United States Environmental Protection Agency. For example, preferred solvents may include one or more of the following: a paraffinic oil, a fatty acid methyl ester, an aromatic petroleum distillate, and a substituted fatty acid amide. Acceptable hard water complexing agent such as citric acid and salts, phosphoric acids and salts, ethylenediaminetetraacetic acid and salts, lignosulfonates, glucoheptonates and the like may be added. Defoamers such as silicone emulsions, hydrophobic silicas, star polymers and the like may be added.

In other embodiments, the composition is produced as a dry formulation by reacting a fatty acid or a fatty acid mixture with urea to produce a clathrate. In still other embodiments, the composition is produced as a dry formulation by blending a fatty acid or a fatty acid mixture on a dry carrier such as clay or on organic material such as corn cob grits or cellulose based granules.

In another aspect, the present invention provides methods of treating replant disease by applying a composition of fatty acid(s) that is effective at treating, controlling, and reversing replant disease in perennial plants susceptible of or suffering from replant disease (plant in need thereof). Any of the fatty acid(s) composition(s) described above may be used with the present methods. The methods include treating soil of an orchard or other land where perennial plants are grown with the fatty acid(s) composition(s) described above. In some embodiments, soil around perennial plants in need of treatment is treated by a) broadcast or directed spraying from a agriculturally acceptable sprayer followed by irrigation b) incorporation into overhead irrigation water or c) incorporation into sub-soil or drip irrigation. Depending on the extensiveness of the symptoms exhibited by the perennial plant, more or less volume per acre of the described compositions can be applied. Likewise, a smaller application area can be treated as desired by the user.

The application of compositions of the present invention may include treating soil before or after new perennial plants are replanted. In some embodiments, a single application is applied to the soil in which a perennial plant will be replanted. In further embodiments, additional treatments are applied to the soil in which a perennial plant will be replanted. In other embodiments, a single application is applied to the soil of a growing perennial plant in need of treatment. In still other embodiments, additional treatments are applied to the soil of a growing perennial plant in need of treatment if symptoms of replant disease are not sufficiently abated. In some embodiments, the compositions of the present invention may be applied to treat replant disease in a variety of perennial plants with susceptibility to replant disease, such as stone fruits (especially Prunus genus plants, such as almond, peach, plum, cherries, etc.), pome fruits (apple, pears, etc.), citrus fruits (orange, grapefruit, lemon, etc.), and other perennial plants (such as blueberry, rose, grapes and others).

### EXAMPLE 1

We formulated a concentrated combination of free fatty acids that included 10% by weight of each of octanoic acid, nonanoic acid, and decanoic acid as active ingredients (Composition 1). Paraffinic acid is used as a solvent/diluent, and emulsifiers/surfactants were included for maintaining the active ingredients in solution when diluted to working concentrations as an aqueous formula for soil application.

TABLE 1

| Composition 1 | % by weight |
|---|---|
| Octanoic acid | 10 |
| Nonanoic acid | 10 |
| Decanoic acid | 10 |
| Solvent | 45 |
| Emulsifier blend | 25 |
| Total | 100 |

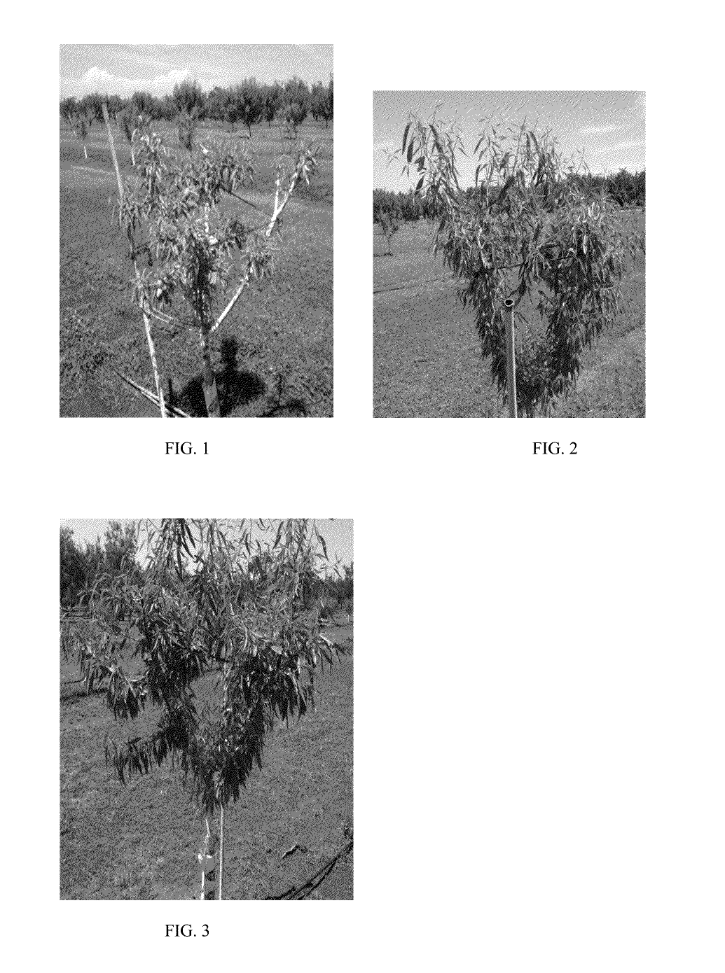

The concentrate Composition 1 was diluted to one and two percent (v:v) aqueous emulsions (1% Composition 1 with 99% water and 2% Composition 1 with 98% water, respectively), and one gallon of the respective aqueous emulsions were sprayed onto a six-foot diameter circle around the base of three year old almond trees in an established almond orchard in Turlock, Calif. in early May 2014. This almond orchard has a history of continuous almond culture and exhibits symptoms of replant disease, including stunting of established plants. This orchard's soil was not fumigated before a portion of the acreage was replanted three years prior to this study. The three year old almond trees selected for this experiment were suffering from symptoms of Prunus Replant Disease, visibly expressed as stunted growth and small leaves. The experimental design was a randomized block design with treatment of three trees per replicate and three replicates of each treatment (1% Composition 1, 2% Composition 1, and untreated controls). Treatments were applied on May 14, 2014. The trees, treated and untreated, were then irrigated with three acre inches of water using a microspray emitter to provide an overhead irrigation. The trees, treated and untreated, did not receive any other differential treatment or irrigation for the duration of the growing season. Pictures of the trees were taken after 60 days (see FIGS. 1-4). Plant shoot growth was measured after twenty weeks (see Table 2).

TABLE 2
New Stem growth (in inches) at 20 Weeks after Treatment^{a,b}

| Replicate | 1 | 2 | 3 | Mean |
|---|---|---|---|---|
| Untreated (control): | 37.6 | 32.7 | 27.7 | 32.7 |
| Treated (1%): | 48.3 | 49.7 | 45.7 | 47.9 |
| Treated (2%): | 47 | 51.7 | 47.7 | 48.8 |

^{a}Data values are the average of five branches per tree and an average of three trees within each of three replicates. Therefore, each replicate value in the table represents the average of 15 branches from three trees.
^{b}1% and 2% treatments are significantly different from untreated control (1 way ANOVA, p = 0.0019)

When applications of 1% and 2% treatments continued at the end of the growing season (October 2014) and the next year prior to leaf bud expansion (March 2015) on the same trees, tree trunk circumference was increased by the treatments (see Table 3).

TABLE 3
Trunk Circumference (in mm) at 14
Months after Initial Treatment ^{a, b}

| Replicate | 1 | 2 | 3 | Mean |
|---|---|---|---|---|
| Untreated (control): | 219.7 | 190 | 194 | 201.2 |
| Treated (1%): | 262.7 | 277.3 | 293.7 | 277.9 |
| Treated (2%): | 299 | 293.7 | 289.7 | 294.1 |

^{a} Data values are taken at 12 inches above soil line and are the average of three trees per replicate.
^{b} 1% and 2% treatments are significantly different from untreated control (1 way ANOVA, p = 0.0003).

### EXAMPLE 2

Grape vines were also treated with 1%, 2%, and 3% prior to bud break in April 2015 (doses listed in Tables 4 & 5). Untreated and treated vines were all treated identically during the growing season. Three vines per replicate were treated with 1 gallon of 1% and 2% solution of Composition 1 followed by irrigation. Two locations were treated, one in Lodi, Calif. (GPS coordinates 38.051119-121.202581, Location 1) and one in Fairfield, Calif. (GPS coordinates 38.298137-121.121595, Location 2). Location 1 consisted of 8 year old Chardonnay grapes irrigated with a micro spray system. Treatments were applied at Location 1 on Apr. 13, 2015, and grapes were harvested on Aug. 20, 2015. Location 2 consisted of 27 year old Zinfandel grapes irrigated with an overhead irrigation system. Treatments were applied on Apr. 14, 2015, and grapes harvested in August 2015.

Results for Location 1 are shown in Table 4 and results for Location 2 are shown in Table 5. All clusters on each vine were harvested and total weight of grapes per three vines was obtained.

TABLE 4
Harvested yield of chardonnay (in grown) grapes treated with
1% and 2% at approximately 18 weeks after treatment.^{a} Values
are total weight of all grapes on 3 vines per replicate.

| Replicate | 1 | 2 | 3 | Mean |
|---|---|---|---|---|
| Untreated (control): | 1664 | 1838 | 1770 | 1757.3 |
| Treated (1%): | 2010 | 2356 | 2605 | 2323.7 |
| Treated (2%): | 3609 | 3329 | 3659 | 3532.3 |

^{a}1% and 2% treatments are significantly different from untreated control (1 way ANOVA, p = 0.0001).

TABLE 5
Harvested yield of Zinfandel (in grams) grapes treated with
2% and 3% approximately 18 weeks after treatment.^{a} Values
are total weight of all grapes on 3 vines per replicate.

| Replicate | 1 | 2 | 3 | Mean |
|---|---|---|---|---|
| Untreated (control): | 1934 | 1262 | 1698 | 1631.3 |
| Treated (2%): | 2692 | 2674 | 2670 | 2678.7 |
| Treated (3%): | 2660 | 2978 | 2515 | 2717.7 |

^{a}2% and 3% treatments are significantly different from untreated control (1 way ANOVA, p = 0.002).

Soil application of 1%, 2%, or 3% treatment solutions resulted in significant increases in harvested fruit yields for both Chardonnay and Zinfandel grape varieties.

Now turning to FIGS. 1-3, representative trees of untreated (FIG. 1), 1% Composition 1 treated (FIG. 2), and 2% Composition 1 treated (FIG. 3) almond trees are shown 60 days after the treatment described in Example 1. The control (untreated) almond tree in FIG. 1 shows classic stunting of Prunus Replant Disease with very little new growth. Surprisingly, the treated almond trees (1% Composition 1 treated (FIG. 2) and 2% Composition 1 treated (FIG. 3)), in contrast, showed a reversal of the stunted growth with many new branches, taller growth, and generally more foliation. As can be seen by comparing FIGS. 2 and 3, the reversal effects of the diluted Composition 1 working solutions had a dose dependent response with more vigorous new growth and foliation in the 2% Composition 1 treated trees (FIG. 2) as compared to the 1% Composition 1 treated trees (FIG. 3).

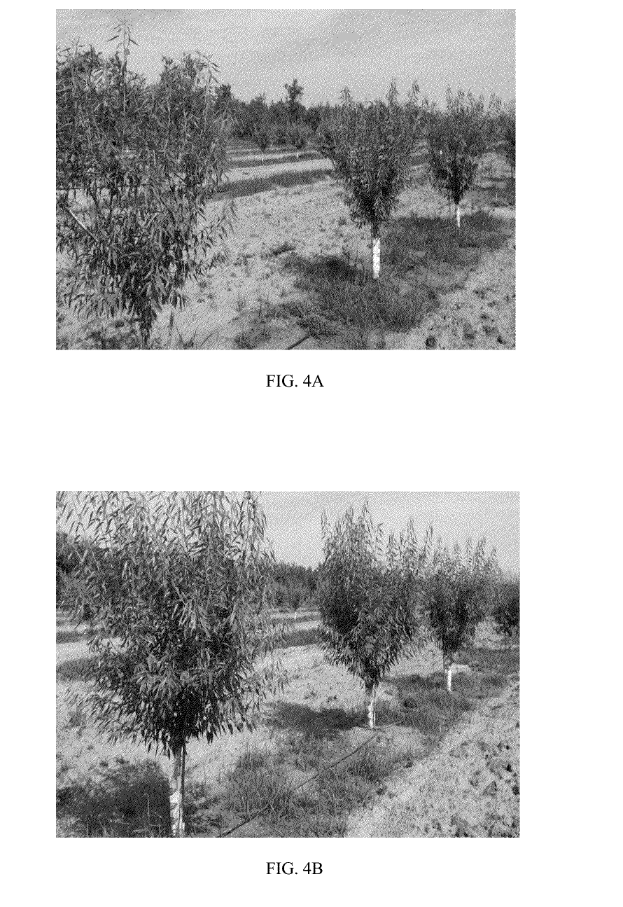

FIGS. 4A and 4B show a comparison of one representative three tree replicate of untreated (FIG. 4A) and 2% Composition 1 treated (FIG. 4B) almond trees 60 days after treatment. As can be seen, the 2% Composition 1 treated almond trees (FIG. 4B) are fuller and significantly higher with more volume compared to the untreated almond trees (FIG. 4A).

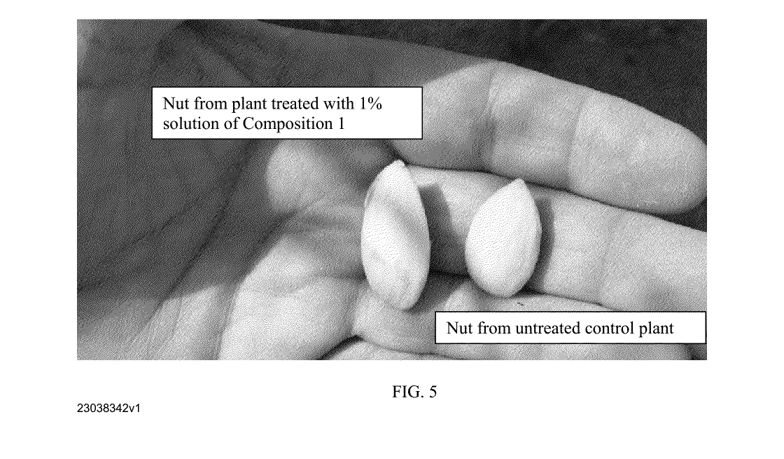

Now turning to FIG. 5, perhaps even more surprising was that the harvested almond nuts from 1% Composition 1 treated almond trees (FIG. 5, left) that had been suffering from Prunus Replant Disease were larger than harvested almond nuts from untreated almond trees (FIG. 5, right). These nuts are from representative three year old trees used in the experiment.

Now turning to Table 6, nematode counts were taken from soil cores extracted beneath untreated and treated trees within the 6 foot diameter treatment area. Four sample cores were taken per tree, composited, and counts of lesion nematodes (Pratylenchus species) taken. As can be seen in Table 6, Pratylenchus species nematode counts in the treated and untreated trees were not significantly different two weeks after treatment.

TABLE 6
Counts of Pratylenchus species in 100 gram soil samples
taken beneath treated (1 and 2% dilutions of Composition 1) and
untreated trees at two weeks after treatment. ^{a, b}

| Replicate | 1 | 2 | 3 | Mean |
|---|---|---|---|---|
| Untreated (control): | 358 | 420 | 321 | 366 |
| Treated (1%): | 1050 | 513 | 58 | 540 |
| Treated (2%): | 852 | 591 | 268 | 570 |

^{a} Data values are the average of two determinations per composited sample.
^{b} 1% and 2% treatments are not significantly different from untreated control (1 way ANOVA, p = 0.75)

Similar results were obtained for nematode counts taken one week after treatment, where no significant differences of nematode count among untreated and treated trees were observed (data not shown).

The results of the nematode counts are consistent with the statement of Browne et al. that replant disease can occur independently from nematode infestation (Browne et al. (2013), supra). The failure of the 1% and 2% treatments to reduce nematode populations while simultaneously causing strong growth stimulation (Table 2) shows that fatty acid treatment can reverse symptoms of replant disease in almonds independently of nematode populations.

As shown in the trees of Example 1, treatment with an emulsion of a fatty acid mixture dramatically improves the growth of trees in an orchard with a history of replant disease, even in post-replant trees. Conventional treatment (fumigation) cannot be performed on living trees, so the disclosed treatment method and compositions provide an environmentally safe and effective treatment for the control of replant disease, even in post-replant trees. Furthermore, we have shown that the disclosed treatment method and compositions lead to increased economic return by producing larger nuts upon harvest than untreated trees.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A composition that controls replant disease consisting of (a) a fatty acid or a mixture of fatty acids and or fatty acid salts, and optionally (b) an emulsifying agent and (c) optionally a solvent, and/or a hard water ion complexing agent, and/or a defoamer.

2. The composition of claim 1, wherein the fatty acids are from C6-C22.

3. The composition of claim 1, wherein the fatty acids are from C8-C16.

4. The composition of claim 1, wherein the fatty acids are from C8-C12.

5. The composition of claim 1, wherein the solvent is any agriculturally acceptable solvent that is approved for use in pesticide formulations by the United States Environmental Protection Agency.

6. The composition of claim 5, wherein the solvent is a paraffinic oil, a fatty acid methyl ester, an aromatic petroleum distillate, substituted fatty acid amide, or a mixture of these.

7. The composition of claim 1, wherein said composition is a dry formulation produced by reacting the fatty acid or the fatty acid mixture with urea to produce a clathrate.

8. The composition of claim 7, wherein the fatty acids are from C6-C22.

9. The composition of claim 7, wherein the fatty acids are from C8-C16.

10. The composition of claim 7, wherein the fatty acids are from C8-C12.

11. The composition of claim 1, wherein said composition is a dry formulation produced by blending the fatty acid or the fatty acid mixture on a dry carrier such as clay, organic material such as corn cob grits or cellulose based granules.

12. The composition of claim 11, wherein the fatty acids are from C6-C22.

13. The composition of claim 11, wherein the fatty acids are from C8-C16.

14. The composition of claim 11, wherein the fatty acids are from C8-C12.

15. A method of treating a plant in need thereof comprising applying the composition of claim 1 to a target soil that causes replant disease symptoms in said plant.

16. The method of claim 15, wherein the composition is applied in undiluted form.

17. The method of claim 15, wherein the composition is diluted to form a water emulsion prior to applying to the target soil.

18. The method of claim 15, wherein the application is made by spraying directly on the target soil followed by irrigation to incorporate the product into the soil.

19. The method of claim 15, wherein the application is made via injecting the composition into an overhead irrigation system.

20. The method of claim 15, wherein the application is made via injecting the composition into a sub-surface or drip irrigation system.

21. The method of claim 15, wherein the composition is applied to soil prior to planting trees, vines, bushes, seeds, or transplants.

22. The method of claim 15, wherein the composition is applied to soil with already established plants.

23. The method of claim 15, wherein the application is made via broadcast or band application followed by irrigation.
